(19) United States
(12) Patent Application Publication
(10) Pub. No.: US 2004/0064421 A1
(43) Pub. Date: Apr. 1, 2004

(54) Computer system cost estimation process and method

(76) Inventor: Philip G. Bailey, Wyoming (AU)

Correspondence Address: FISH & RICHARDSON P.C., 1425 K STREET, N.W., 11TH FLOOR, WASHINGTON, DC, 20005-3500, US

(21) Appl. No.: 10/259,191

(22) Filed: Sep. 26, 2002

(51) Int. Cl. G06G 7/00

(52) U.S. Cl. 705/400

(57) ABSTRACT

An automated cost estimation process includes a unit cost determination process for determining a per-unit multiplier for a client computational bandwidth requirement. The client computational bandwidth requirement, which is obtained from a client, is indicative of the client's anticipated system load. An analysis process determines a total computational cost based on the per-unit multiplier and the client computational bandwidth requirement.

### TECHNICAL FIELD

This description relates to techniques for estimating the cost of computer systems.

### BACKGROUND

Computer systems, especially those incorporating mini, midrange and mainframe computers, are expensive to install, deploy, and maintain. In addition to the costs associated with system installation, hardware, and software, the expense of maintaining and updating the system is also considerable.

In light of these expenses, clients often outsource their mainframe computing and system needs to service providers that maintain and operate centralized mainframe computer systems. These service providers contract with the clients and provide them with the required computer resources. The value of these contracts is based on, among other things, the length of the contract and the specific needs and computational requirements of the client. The clients access these centralized mainframe computer systems using computer terminals located at the clients' worksite.

### SUMMARY

In one general aspect, a cost estimation process includes a unit cost determination process for determining a per-unit multiplier for a client computational bandwidth requirement. The client computational bandwidth requirement, which is obtained from a client, is indicative of the client's anticipated system load. An analysis process determines a total computational cost based on the per-unit multiplier and the client computational bandwidth requirement.

Implementations of the process may include one or more of the following features. For example, the analysis process may include a cost adjustment process to adjust the total computational cost by a differential amount, based on a level of security represented by a security parameter. This adjustment generates a modified computational cost. A report generation process may provide a user with a report itemizing the total computational cost, the modified computational cost, and the differential amount.

The security parameter may include a staff parameter, a facilities parameter, a hardware parameter, and a software parameter. The client computational bandwidth requirement may be a MIPS (millions of instructions per second) indicator. The unit cost determination process may include a functional process for determining the per-unit multiplier based on a continuous functional relationship, or a look-up process for determining the per-unit multiplier based on one or more discrete relationships.

The above-described processes may also be implemented as a method or a sequence of instructions executed by a processor.

The process of estimating the long-term installation, implementation and management costs of a computer system can be standardized and automated. Further, due to this standardization and automation, the estimates generated can be more consistent and produced more quickly. By allowing the client to adjust the security level of the client's computer system, the cost of the system can be adjusted to meet the client's budget while maintaining a selected level of security.

Other features will be apparent from the following description, including the drawings, and the claims.

### DESCRIPTION OF DRAWINGS

FIG. 1 is a block diagram of a computer network that may be used to implement a computer system cost estimation process.

FIG. 2 is a block diagram of a computer system cost estimation process.

FIG. 3 is a flowchart showing one implementation of the interaction of the individual processes included in the computer system cost estimation process of FIG. 2.

FIG. 4 is a diagrammatic view of a report generated by the computer system cost estimation process of FIG. 2.

FIG. 5 is a block diagram of a computer system cost estimation method.

### DETAILED DESCRIPTION

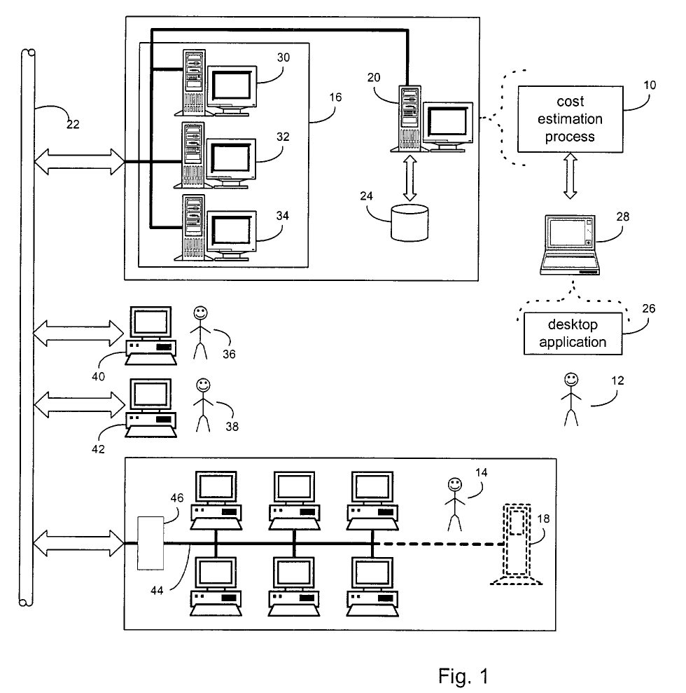

Referring to FIG. 1, a cost estimation process 10 allows a user 12 to quickly generate an estimate of the cost to a potential client 14 of using a remote computer system 16 maintained by a service provider, relative to the cost of setting up and maintaining a local computer system 18 (shown in phantom). By using the remote computer system 16, the potential client 14 may benefit from cost savings that result from sharing the remote computer system 16 with other clients, so as to reduce the individual cost to each client of the remote computer system.

Cost estimation process 10 resides on and is executed by a computer 20 that is connected to a network 22 (e.g., the Internet, an intranet, a local area network, or some other form of network). The instruction sets and subroutines of cost estimation process 10 are typically stored on a storage device 24 connected to computer 20. Storage device 24 may be, for example, a hard disk drive, a tape drive, an optical drive, a RAID array, a random access memory (RAM), or a read-only memory (ROM). User 12 typically accesses and uses cost estimation process 10 through a desktop application 26 (e.g., Microsoft Internet Explorer™, Netscape Navigator™, or a specialized desktop interface) running on a computer 28.

Typically, remote computer system 16 includes one or more servers or mainframes 30, 32, 34 that are accessed and used by multiple clients 36, 38. These clients access the remote computer system 16 using computer terminals 40, 42 that are also connected to network 22. Terminals 40, 42 communicate with mainframes 30, 32, 34 using a standard communication protocol (e.g., TCP/IP, IPX) or a proprietary communication protocol. Typically, a client will have more than one terminal and, therefore, these terminals may be interconnected with a secondary network 44 that interfaces network 22 with, for example, a router 46.

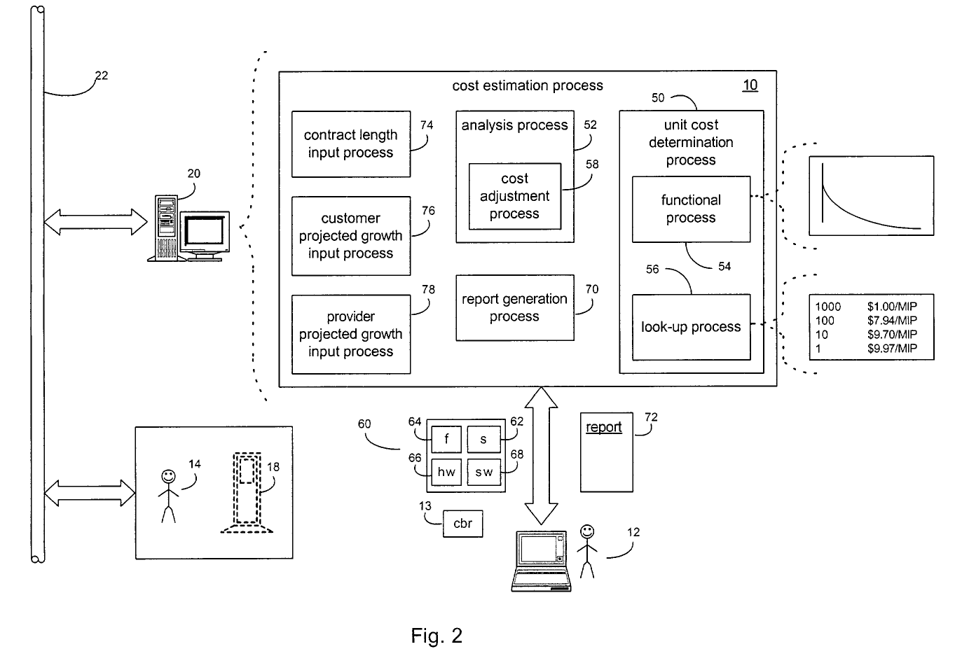

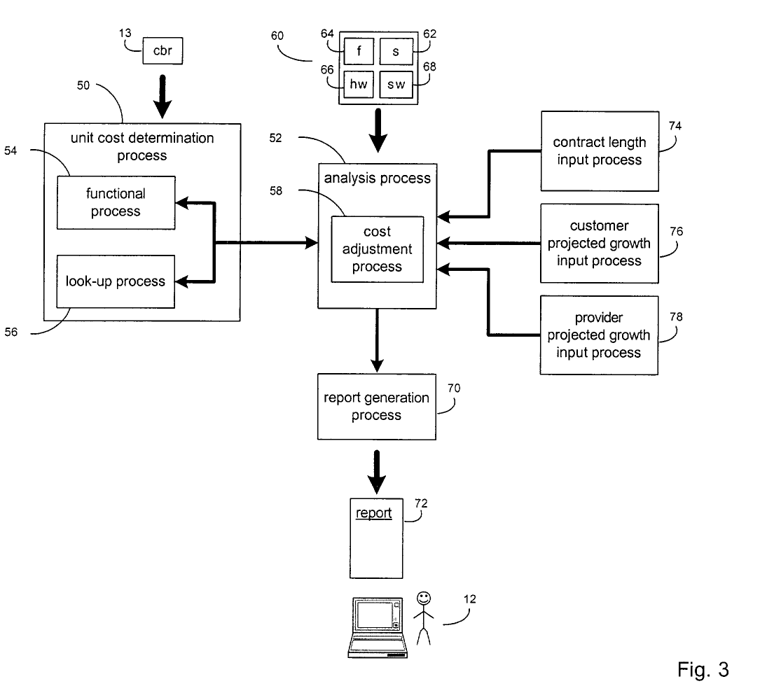

Referring to FIGS. 2 and 3, cost estimation process 10 includes a unit cost determination process 50 for determining a per-unit multiplier for a client's computational bandwidth requirement. As will be explained below, this computational bandwidth requirement (or cost driver) greatly influences the overall cost of the system to the client. Further, the per-unit multiplier is based on a defined period of time (to be explained below in greater detail). Prior to generating the estimate concerning potential client 14, user 12 obtains information from the potential client concerning that potential client's mainframe usage requirements (including the client's computational bandwidth requirement 13). The computational bandwidth requirement, which is usually expressed in MIPS (millions of instructions per second), represents the load that the potential client anticipates placing on the mainframe. Other load indicators (as opposed to MIPS) are sometimes used, such as: CPU hours; CPW (i.e., commercial processing workload); and MHz (i.e., megahertz), for example.

Typically, a server or mainframe is rated in accordance with the number of MIPS it is capable of performing, and these available MIPS can be divided up amongst multiple clients. For example, if a mainframe is capable of performing one thousand MIPS, that mainframe can simultaneously service ten clients who each need approximately one hundred MIPS. This sharing of mainframes (and the related software, support staff, and facilities) is the basis of the cost reductions that a potential client can achieve if the client chooses to share a remote computer system with other clients.

Once user 12 obtains the computational bandwidth requirement from potential client 14, unit cost determination process 50 determines the per-unit multiplier that is associated with that requirement. The per-unit multiplier is often expressed in dollars per MIPS, such that the cost per MIPS is inversely proportional to the total MIPS required. For example, while the per-unit multiplier for a two-hundred MIPS client may be $10 per MIPS, the per-unit multiplier for a four-hundred MIPS client may be only $8 per MIPS. Examples of how the per-unit multiplier is determined are discussed below.

Once the per-unit multiplier is determined, an analysis process 52 calculates the total computational cost for that potential client. This total computational cost, which is the product of the per-unit multiplier and the computational bandwidth requirement, represents an estimate of the cost to the potential client for installation, implementation and management of a local computer system 18 for a defined period of time. As local computer system 18 is a dedicated, stand-alone system that is only accessible by potential client 12, the cost reductions due to sharing do not apply and the dedicated, stand-alone system is more expensive than a remote computer system 16 (as shown in FIG. 1) that is shared with other clients.

The total computational cost may be presented in various formats depending on the manner in which the computational bandwidth requirement is calculated. For example, the computational bandwidth requirement may be expressed as an average, steady-state measurement or as a maximum transient measurement. Further, and as stated above, the per-unit cost is associated with a defined period of time (e.g., a day, a week, a month, or a year) and, therefore, the calculated total computational cost is the cost associated with providing the potential client with that service for that defined period of time. For example, if potential client 14 was considering installing a four-hundred MIPS system, the per-unit multiplier for that system is $8.00 per MIPS (as stated above). Therefore, the total computational cost is $3,200. This represents the cost of providing that potential client with a stand-alone dedicated system (e.g., system 18) for a defined period of time (e.g., one year).

Unit cost determination process 50 is defined and implemented by compiling data concerning a large number of installed computer systems. The data collected may include, for example, hardware costs, software costs, facilities costs, staffing costs, infrastructure costs, utility costs, and maintenance and repair costs. These installed computer systems may be systems that are installed and maintained by user 12 (i.e., the service provider) or systems that are installed and maintained by third parties. Once this data is collected, a relationship may be determined between total MIPS required and the average cost per MIPS at that requirement level.

Unit cost determination process 50 may include one or more of a functional process 54 or a look-up process 56 depending on the manner in which the process 50 is implemented.

If a functional process 54 is included, unit cost determination process 50 is configured as a function or algorithm so that the per-unit multiplier is calculated when a computational bandwidth requirement is input into the unit cost determination process. For example, if the data collected to define unit cost determination process 50 indicates that the per-unit multiplier (M) relates to the computational bandwidth requirement (B) as follows:

M=10×(10^{-001B}),

then an exponential decay relationship would be defined by functional process 54. As this relationship is defined as a function, it is a continuous relationship and, therefore, the per-unit multiplier for any computational bandwidth requirement can be directly calculated.

If unit cost determination process 50 includes a look-up process 56, the same relationship may be defined through the use of a look-up table. For example, the following table:

| computational BW | per-unit |
|---|---|
| requirement (B) | multiplier (M) |
| 1000 MIPS | $1.00 / MIP |
| 100 MIPS | $7.94 / MIP |
| 10 MIPS | $9.70 / MIP |
| 1 MIPS | $9.97 / MIP |

is the look-up table equivalent of the function M=10×(10^{-0.001B}). However, look-up tables (by definition) are not continuous and include multiple discrete entries or relationships. In this particular example, there are four discrete relationships for computational bandwidth requirements of 1000 MIPS, 100 MIPS, 10 MIPS, and 1 MIPS. If the potential client had a computational bandwidth requirement that fell between one of these four values, look-up process 50 would interpolate between the values to determine the per-unit multiplier. For example, if the potential client specified a computational bandwidth requirement of 55 MIPS, a linear interpolation of the above-listed relevant relationships results in a per-unit multiplier of $8.82 per MIPS.

For the computational bandwidth requirements of 1000 MIPS, 100 MIPS, 10 MIPS, and 1 MIPS, the total computational costs (as determined by analysis process 52) are $1,000.00, $790.00, $97.00, and $9.97 respectively. As stated above, the total computational cost represents the cost to a potential client for the installation, implementation and management of a local computer system 18 for a defined period of time. This potential client can experience savings if they are willing to share hardware, software, staff, and/or facilities.

Analysis process 52 includes a cost adjustment process 58 for adjusting the total computational cost in response to user 12 defining a security parameter 60 for potential client 14. This security parameter 60 defines the security level at which potential client 14 wishes to configure and maintain a shared system. This security parameter 60 includes a staff parameter 62, a facilities parameter 64, a hardware parameter 66, and a software parameter 68.

The cost of a staff may be, for example, 40% of the total computational cost. The staff parameter defines whether the potential client 14 wishes to share with other clients the staff that maintains the system.

The cost of the facilities (e.g., the building that houses the system, the utilities that power the system, building maintenance) may be, for example, 5% of the total computational cost. The facilities parameter defines whether the potential client 14 wishes to share with other clients the facility in which the system is housed.

The cost of hardware may be, for example, 25% of the total computational cost. The hardware parameter defines whether potential client 14 wishes to share with other clients the hardware of the system. Typically, the system hardware includes, for example, CPU(s), hard disks, and tape units.

The cost of software may be, for example, 30% of the total computational cost. The software parameter defines whether potential client 14 wishes to share software with other clients.

The individual security parameters are used to adjust the total computational cost. In one implementation, the adjustments are made as pro-rata discounts. This process may be illustrated using an example that is vastly simpler than the systems to which cost estimation process 10 would be applied in actual use. In this example, if a mainframe capable of 1000 MIPS is shared by an existing client that uses 600 MIPS and a potential client that will use 400 MIPS, sharing that mainframe results in the potential client saving 60% of the hardware costs, which constitutes a 15% reduction in total computation costs when hardware constitutes 25% of the total computational cost. Specifically, for a 400 MIPS systems, the per-unit multiplier is $3.98 per MIPS, resulting in a total computational cost of $1,592. As stated above, 25% of this cost (i.e., $398) represents hardware cost. Therefore, by sharing a 1000 MIPS server with a client that uses 600 MIPS, the potential client will only use and pay for 40% of that server (i.e., the hardware cost). Accordingly, by sharing the server, the potential client would save $238.80 (60% of $398). The discounts concerning software sharing, facilities sharing, and staff sharing are all calculated similarly and, when summed, represent the total amount of the discount resulting from sharing hardware, software, facilities, and staff, which may be referred to as the differential amount. The cost adjustment process 58 determines a modified computational cost by subtracting this differential amount from the total computational cost.

Cost estimation process 10 includes a report generation process 70 for generating a report 72 that itemizes the total computational cost, the differential amount, and the modified computational cost. This report, in the form of an estimate or bid, is provided by user 12 to potential client 14. Continuing with the example from above, for the same 400 MIPS system, if potential client 14 wished to share hardware, software, facilities, and staff, the individual pro-rata discounts would be as follows: a $238.80 hardware discount, a $286.56 software discount, a $47.76 facilities discount, and a $382.08 staff discount. This results in a total discount of $955.20 (i.e., the differential amount), which represents 60% of the $1,592 total computational cost. Accordingly, report 72 would include the total computational cost of $1,592.00, the differential amount of $955.20, and the modified computational cost of $636.80 (i.e., $1,592.00 $955.20).

Cost estimation process 10 generates a report 72 that specifies the cost of providing a potential client with a remote computer system for a defined period of time (i.e., the contract length). As this period of time increases, the probability for change of the bases on which report 72 was generated also increases. For example, while the potential client described above requested a 400 MIPS system, if that client predicts 10% growth per year, it is foreseeable that after five years, that potential client would need a 644 MIPS system (i.e., 400 MIPS×1.10⁵).

Accordingly, cost estimation process 10 includes a contract length input process 74 for entering the length of the contract (typically in years) and a client projected growth input process 76 for entering a projected growth parameter for the client. This projected growth may be entered as a percentage (as described above) or as individual MIPS entries for each year of the contract. Therefore, when a potential client wishes to enter into a multi-year contract, the total computational cost will be calculated by analysis process 52 so that it is the sum of multiple single-year contracts (less any multi-year contract discounts). For example, if potential client 14 entered into a five year contract for a 400 MIPS system but predicted 10% growth per year, the total computational cost would be calculated as the sum of a one year contract for a 400 MIPS system, a one year contract for a 440 MIPS system, a one year contract for a 484 MIPS system, a one year contract for a 532 MIPS system, and a one year contract for a 586 MIPS system. After the completion of that fifth year, the potential client would need a 644 MIPS system. Therefore, five sets of calculations would be performed by analysis process 52 and these calculations would be summed by analysis process 52 to determine the modified computational cost for the five year span.

As the discounting in process 10 is based on economies-of-scale, if the service provider predicts an increase in their installed base (e.g., more clients, more mainframes, or more facilities), the per-unit cost determined by unit cost determination process will decrease as a larger number of clients are available to split the system costs. Additionally, advances in mainframe technology increase the MIPS-per-dollar ratio, further decreasing the per-unit cost. Accordingly, process 10 includes a provider projected growth input process 78 for allowing user 12 (or an administrator of process 10) to configure the provider's anticipated growth, such that this predicted growth of the provider would be used to discount the per-unit cost over the lifetime of the contract. Therefore, if the provider predicted 20% annual growth and this growth would account for a 10% annual reduction in the per-unit cost, the $3.98 per MIPS per-unit cost calculated above could be discounted by unit cost determination process 50 to $3.98 per MIPS for the first year, $3.58 per MIPS for the second year, $3.22 per MIPS for the third year, $2.90 per MIPS for the fourth year, and $2.61 per MIPS for the fifth year.

FIG. 3 illustrates one implementation of the interaction of the individual processes included in the cost estimation process 10.

While process 10 is described above as being used to calculate the cost of a new system, process 10 may also be used to calculate the cost of expanding/modifying an existing system.

While the staff, facilities, hardware, and software parameters are typically binary parameters (i.e., hardware is or is not shared), these parameters may be fine tuned to permit certain portions of the system to be partially shared. For example, a potential client may only wish to share certain portions of the hardware, such as sharing the processing hardware (e.g., system board and central processing units) but not sharing the data storage hardware (e.g., disk arrays, tape arrays).

While the total computational cost is described above as being the most-expensive cost, as it represents the costs associated with a stand-alone system, other configurations are possible. For example, process 10 can be configured so that the total computational cost calculated represents the least expensive solution, in that it would represent the cost of a system that shares hardware, software, staff and facilities. This cost can then be adjusted upwardly (by cost adjustment process 58) in response to the potential client choosing a system that shares less components.

While process 10 is described above as residing on and being executed by a computer 20 that is connected to network 22, other configurations are possible. For example, process 10 may reside on the hard disk drive (not shown) of computer 28 (e.g., a laptop computer) that is taken to the worksite of potential client 14 by user 12. Therefore, computer 28 may not be continuously connected to network 22 or computer 20. Alternatively, data may be transferred between computer 28 and computer 20 using a removable storage device, such as a floppy disk or a writeable CD-ROM disk.

While remote computer system 16 is shown to include three mainframe computers 30, 32, 34, the exact number of mainframes will vary depending on the needs of clients 36, 38. Further, remote computer system 16 may include additional components such as, for example, disk arrays and tape arrays.

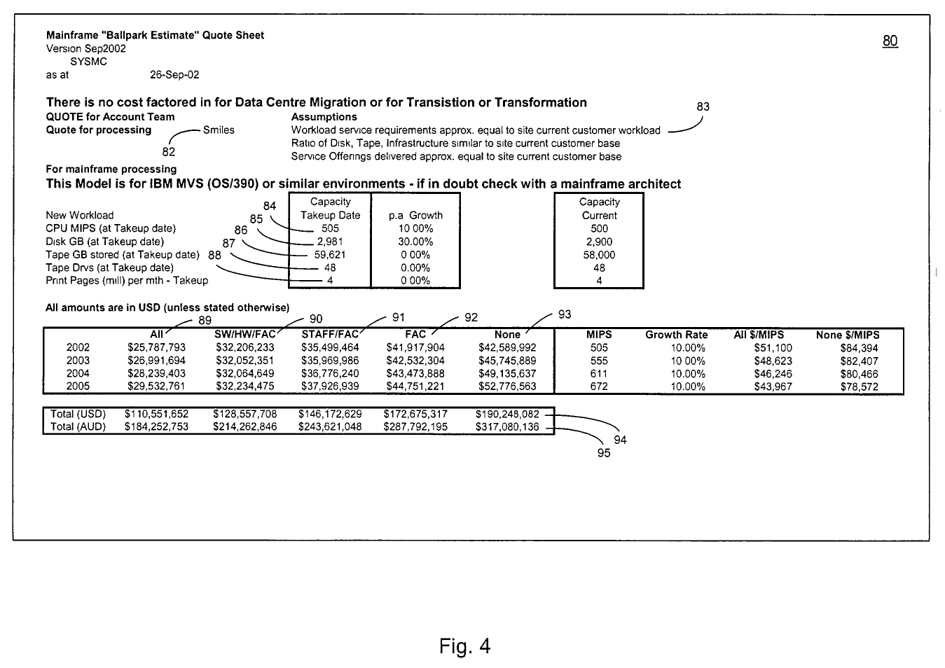

While report 72 is described above as including only cursory information, other report configurations are possible. Referring to FIG. 4, a more complex report 80 may be generated. This report 80 may include, for example, additional information such as potential client identifier 82, quote assumptions 83, MIPS indicator 84, estimated allotted disk storage space 85, estimated allotted tape storage space 86, number of tape drives 87, estimated pages printed per month 88, various sharing scenarios 89, 90, 91, 92, 93, quote totals in U.S. dollars 94, and quote totals in another currency (e.g., Australian dollars) 95.

Quote assumptions 83 specify the base assumptions used to generate the report. Allotted disk storage space 85, allotted tape storage space 86, the number of tape drives 87, and the estimated pages printed per month 88 are assumptions that are typically included in the hardware cost of the system (unless the assumed values are excessive). The particular sharing scenarios included in more complex report 80 are “ALL” (i.e., sharing everything, namely staff, facilities, hardware, and software), “SW/HW/FAC” (i.e., sharing software, hardware, and facilities only), STAFF/FAC (i.e., sharing staff and facilities only), “FAC” (i.e., sharing facilities only), and “NONE” (not sharing anything).

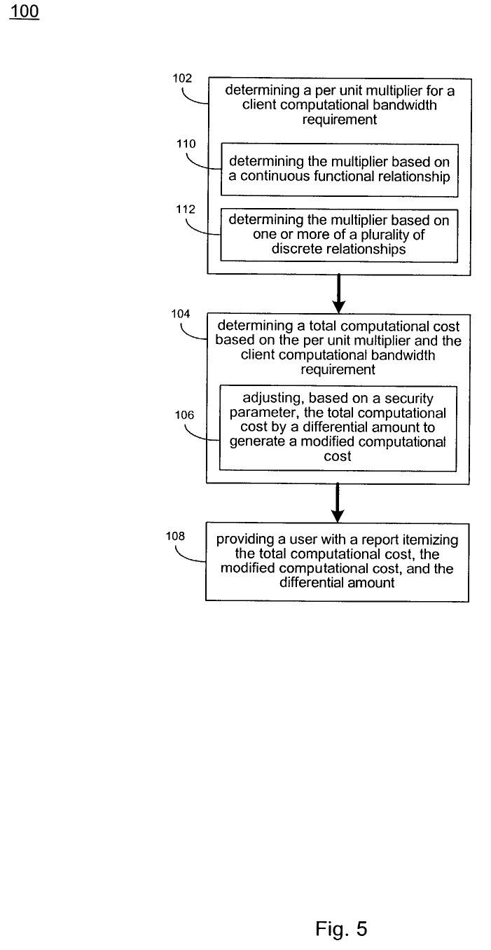

Referring to FIG. 5, a cost estimation method 100 includes determining a per-unit multiplier for a client computational bandwidth requirement (102). A total computational cost is determined based on the per-unit multiplier and the client computational bandwidth requirement (104).

Determining a total computational cost (104) includes adjusting the total computational cost by a differential amount based on a security parameter (106). This adjustment generates a modified computational cost. A user is provided with a report that itemizes the total computational cost, the modified computational cost, and the differential amount (108). The security parameter may include a staff parameter, a facilities parameter, a hardware parameter, or a software parameter. The client computational bandwidth requirement is a MIPS indicator.

Determining a per-unit multiplier (102) may include determining the multiplier based on a continuous functional relationship (110), or determining the multiplier based on one or more discrete relationships (112).

The cost estimation process described herein is not limited to the hardware implementation described above; it may find applicability in any computing or processing environment. The cost estimation process may be implemented in hardware, software, or a combination of the two. For example, the cost estimation process may be implemented using circuitry, such as one or more of programmable logic (e.g., an ASIC), logic gates, a processor, and a memory.

The cost estimation process may be implemented in computer programs executing on programmable computers that each include a processor and a storage medium readable by the processor (including volatile and non-volatile memory and/or storage elements). Each such program may be implemented in a high-level procedural or object-oriented programming language to communicate with a computer system. The programs also may be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the cost estimation process. The cost estimation process may also be implemented as a machine-readable storage medium, configured with a computer program, wherein, upon execution, instructions in the computer program cause a machine to operate to perform the functions of the cost estimation process described above.

Implementations of the cost estimation process may be used in a variety of applications. Although the cost estimation process is not limited in this respect, the cost estimation process may be implemented with memory devices in microcontrollers, general purpose microprocessors, digital signal processors (DSPs), reduced instruction-set computing (RISC), and complex instruction-set computing (CISC), among other electronic components.

The cost estimation process may also be implemented using integrated circuit blocks referred to as main memory, cache memory, or other types of memory that store electronic instructions to be executed by a microprocessor or store data that may be used in arithmetic operations.

A number of implementations have been described. Nevertheless, it will be understood that various modifications may be made. Accordingly, other implementations are within the scope of the following claims.

What is claimed is:

1. An automated cost estimation process comprising:
a unit cost determination process for determining a per-unit multiplier for a client computational bandwidth requirement, wherein the client computational bandwidth requirement is obtained from a client and is indicative of the client's anticipated system load; and
an analysis process for determining a total computational cost based on the per-unit multiplier and the client computational bandwidth requirement.

2. The cost estimation process of claim 1 wherein the analysis process includes a cost adjustment process to adjust, based on a level of security represented by a security parameter, the total computational cost by a differential amount to generate a modified computational cost.

3. The cost estimation process of claim 2 further comprising a report generation process for providing a user with a report itemizing the total computational cost, the modified computational cost, and the differential amount.

4. The cost estimation process of claim 2 wherein the security parameter includes a staff parameter indicative of the client's interest in staff sharing.

5. The cost estimation process of claim 2 wherein the security parameter includes a facilities parameter indicative of the client's interest in facilities sharing.

6. The cost estimation process of claim 2 wherein the security parameter includes a hardware parameter indicative of the client's interest in hardware sharing.

7. The cost estimation process of claim 2 wherein the security parameter includes a software parameter indicative of the client's interest in software sharing.

8. The cost estimation process of claim 1 wherein the client computational bandwidth requirement is a MIPS indicator

9. The cost estimation process of claim 1 wherein the unit cost determination process includes a functional process for determining the per-unit multiplier based on a continuous functional relationship.

10. The cost estimation process of claim 1 wherein the unit cost determination process includes a look-up process for determining the per-unit multiplier based on one or more discrete relationships.

11. A cost estimation method comprising:
obtaining, from a client, a client computational bandwidth requirement that is indicative of the client's anticipated system load;
determining a per-unit multiplier for the client computational bandwidth requirement; and
determining a total computational cost based on the per-unit multiplier and the client computational bandwidth requirement.

12. The cost estimation method of claim 11 wherein determining a total computational cost includes adjusting, based on a level of security represented by a security parameter, the total computational cost by a differential amount to generate a modified computational cost.

13. The cost estimation method of claim 12 further comprising providing a user with a report itemizing the total computational cost, the modified computational cost, and the differential amount.

14. The cost estimation method of claim 12 wherein the security parameter includes a staff parameter indicative of the client's interest in staff sharing.

15. The cost estimation method of claim 12 wherein the security parameter includes a facilities parameter indicative of the client's interest in facilities sharing.

16. The cost estimation method of claim 12 wherein the security parameter includes a hardware parameter indicative of the client's interest in hardware sharing.

17. The cost estimation method of claim 12 wherein the security parameter includes a software parameter indicative of the client's interest in software sharing.

18. The cost estimation method of claim 11 wherein the client computational bandwidth requirement is a MIPS indicator.

19. The cost estimation method of claim 11 wherein determining a per-unit multiplier includes determining the multiplier based on a continuous functional relationship.

20. The cost estimation method of claim 11 wherein determining a per-unit multiplier includes determining the multiplier based on one or more discrete relationships.

21. A computer program product residing on a computer readable medium having a plurality of instructions stored thereon which, when executed by the processor, cause that processor to:
determine a per-unit multiplier for a client computational bandwidth requirement, wherein the client computational bandwidth requirement is obtained from a client and is indicative of the client's anticipated system load; and
determine a total computational cost based on the per-unit multiplier and the client computational bandwidth requirement.

22. The computer program product of claim 21 wherein instructions that cause the processor to determine a total computational cost include instructions to adjust, based on a level of security represented by a security parameter, the total computational cost by a differential amount to generate a modified computational cost.

23. The computer program product of claim 22 further comprising instructions to provide a user with a report itemizing the total computational cost, the modified computational cost, and the differential amount.

24. The computer program product of claim 21 wherein determining a per-unit multiplier includes instructions to determine the multiplier based on a continuous functional relationship.

25. The computer program product of claim 21 wherein determining a per-unit multiplier includes instructions to determine the multiplier based on one or more discrete relationships.

26. The computer program product of claim 21 wherein the client computational bandwidth requirement is a MIPS indicator.
